(19) United States
(12) Patent Application Publication
(10) Pub. No.: US 2025/0227418 A1
(43) Pub. Date: Jul. 10, 2025

(54) GLASS DIAPHRAGM MODULE

(71) Applicant: AGC Inc., Tokyo (JP)

(72) Inventors: Kento SAKURAI, Tokyo (JP); Jun AKIYAMA, Tokyo (JP)

(73) Assignee: AGC Inc., Tokyo (JP)

(21) Appl. No.: 19/088,597

(22) Filed: Mar. 24, 2025

Related U.S. Application Data
(63) Continuation of application No. PCT/JP2023/032824, filed on Sep. 8, 2023.

(30) Foreign Application Priority Data
Sep. 30, 2022 (JP) 2022-158995

(51) Int. Cl. H04R 7/04; H04R 1/02; H04R 7/18

(52) U.S. Cl. CPC H04R 7/04; H04R 1/025; H04R 7/18; H04R 2307/023; H04R 2400/11; H04R 2499/13

(57) ABSTRACT

The glass diaphragm module includes: a glass diaphragm including a glass plate structure and an exciter that is attached to the glass plate structure; a first member that is attached to a peripheral end portion of the glass diaphragm via a resin layer; and a second member that is arranged away from the glass diaphragm and that is connected to the first member, and a Young's modulus E₁ of the first member and a Young's modulus E₂ of the second member satisfy E₂/E₁≥10.

### CROSS-REFERENCE TO RELATED APPLICATIONS

This application is a continuation application of International Application No. PCT/JP2023/0 32824 filed Sep. 8, 2023 the disclosure of which is incorporated herein by reference in its entirety. Further, this application claims priorities from Japanese Patent Application No. 2022-158995 filed Sep. 30, 2022, the disclosure of which is incorporated herein by reference in their entirety.

### TECHNICAL FIELD

The present disclosure relates to a glass diaphragm module.

### RELATED ART

In recent years, a technique for causing a glass plate to function as a speaker by vibrating the glass plate has been studied. International Publication (WO) No. 2022/009180 discloses a structure in which a transducer is sealed in a laminated glass including an outer side glass layer, an inner side glass layer, and an intermediate layer, whereby the laminated glass is caused to function as a speaker. Furthermore, U.S. Patent Application Publication No. 2015/0298656 discloses a structure in which plural exciters are installed at a windshield of a vehicle, whereby the windshield is caused to function as a speaker. Japanese Patent Application Laid-Open (JP-A) No. 2021-180486 discloses a structure in which an acoustic generator is arranged at a window glass for a vehicle, and the window glass for a vehicle is caused to vibrate to output sound.

However, in a structure in which a speaker function is realized by causing a glass plate to vibrate as in aforementioned Patent Documents 1 to 3, there is a risk that, due to vibration of the glass plate propagating to components that fix a periphery of the glass plate, unpredictable sound that is different from sound that was originally intended to be generated by the glass plate, i.e., noise, may be generated, and in some cases, it becomes difficult to generate the original high sound quality.

### SUMMARY

An object of the present disclosure is to realize a glass diaphragm module capable of suppressing generation of noise, which is a component that is different from sound that is generated by causing a glass plate structure to vibrate.

A glass diaphragm module according to the present disclosure includes: a glass diaphragm including a glass plate structure and an exciter that is attached to the glass plate structure; a first member that is attached to a peripheral end portion of the glass diaphragm via a resin layer; and a second member that is arranged away from the glass diaphragm and that is connected to the first member, and a Young's modulus E₁ of the first member and a Young's modulus E₂ of the second member satisfy E₂/E₁≥10.

In the glass diaphragm module according to the present disclosure, generation of noise, which is a component that is different from sound that is generated by causing the glass plate structure to vibrate, can be suppressed.

### BRIEF DESCRIPTION OF DRAWINGS

FIG. 1 is a schematic view of a glass diaphragm module according to a first exemplary embodiment as viewed from a rear side of a vehicle.

FIG. 2 is a cross-sectional view taken along line 2-2 in FIG. 1.

FIG. 3 is a schematic view of a glass diaphragm module according to a second exemplary embodiment as viewed from a side of a vehicle.

FIG. 4 is a cross-sectional view of a glass diaphragm module according to a third exemplary embodiment as viewed from the side.

FIG. 5 is a schematic view of a glass diaphragm module according to a fourth exemplary embodiment as viewed from an indoor side.

FIG. 6 is a front view illustrating a state in which a glass diaphragm module of an Example is in the process of being assembled.

FIG. 7 is a front view illustrating the glass diaphragm module of the Example.

FIG. 8 is a cross-sectional view taken along line 8-8 in FIG. 7, with a portion cut away.

### DETAILED DESCRIPTION

### First Exemplary Embodiment

A glass diaphragm module 10 according to a first exemplary embodiment will be explained with reference to the drawings.

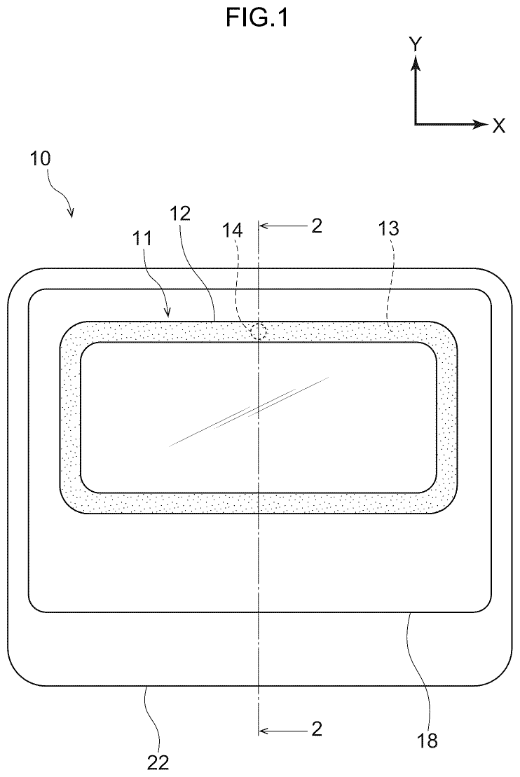

FIG. 1 is a schematic view the glass diaphragm module 10 as viewed from a rear side of a vehicle. As shown in FIG. 1, the glass diaphragm module 10 of the present exemplary embodiment includes a glass diaphragm 11, and the glass diaphragm 11 includes a glass plate structure 12 and an exciter 14.

The glass plate structure 12 can be used for a window glass for a vehicle, such as a windshield, a side glass, a rear glass, a rear quarter glass, a front bench glass, a roof glass, or the like, but can also be used in applications other than for vehicles, such as a window glass for a railway, an aircraft, architecture, or the like.

FIG. 1 is an example in which the glass plate structure 12 is used as a rear glass arranged at a rear portion of a vehicle. It should be noted that, in FIG. 1, an X-axis represents a vehicle width direction in a state in which the glass plate structure 12 has been assembled to the vehicle, and a vehicle right side coincides with a positive direction of the X-axis. Furthermore, a Y-axis represents a vertical direction in a state in which the glass plate structure 12 has been assembled to the vehicle, and a vehicle upper side coincides with a positive direction of the Y-axis.

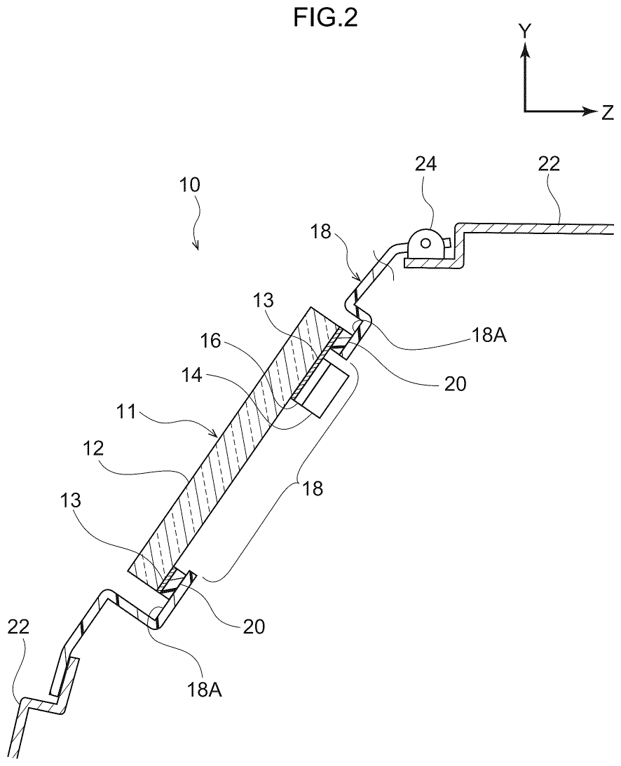

FIG. 2 is a cross-sectional view taken along line 2-2 in FIG. 1, and a Z-axis in FIG. 2 represents a vehicle front-rear direction in a state in which the glass plate structure 12 has been assembled to the vehicle. Although the glass plate structure 12 is configured by a single-plate glass as shown in FIG. 2, it may also be configured by a laminated glass. The glass plate structure 12 is formed by a transparent or translucent inorganic glass. As the inorganic glass, for example, a soda-lime glass, an aluminosilicate glass, a borosilicate glass, an alkali-free glass, a quartz glass or the like can be used.

The glass plate structure 12 may also be formed by an organic glass. As the organic glass, for example, a PMMA (polymethyl methacrylate)-based resin, a PC (polycarbonate)-based resin, a PS (polystyrene)-based resin, a PET (polyethyleneterephthalate)-based resin, a PVC (polyvinyl chloride)-based resin, a cellulose-based resin, or the like can be used.

A thickness of the glass plate structure 12 is preferably 1.0 [mm] or more, more preferably 2.0 [mm] or more, and still more preferably 3.0 [mm] or more. As a result, the glass plate structure 12 can have necessary and sufficient strength. Furthermore, the thickness of the glass plate structure 12 is preferably 7.0 [mm] or less, more preferably 6.0 [mm] or less, and still more preferably 5.0 [mm] or less.

Furthermore, in a case in which the glass plate structure 12 is configured by a laminated glass in which an intermediate layer is interposed between a pair of glass plates, a thickness of each of the pair of glass plates configuring the glass plate structure 12 is preferably 0.1 [mm] or more, more preferably 0.5 [mm] or more, and still more preferably 1.0 [mm] or more. It should be noted that thicknesses of the pair of glass plates configuring the glass plate structure 12 may be the same or different.

Examples of the intermediate layer in a case in which the glass plate structure 12 is a laminated glass include transparent polyvinyl butyral (PVB)-based or ethylene-vinyl acetate copolymer (EVA)-based resin films and resin films containing thermosetting adhesive materials such as silicone (PDMS)-based, polyurethane-based, fluorine-based, polyethylene terephthalate-based, and polycarbonate-based thermosetting adhesive materials. Furthermore, a material that enhances sound insulation, a material that absorbs ultraviolet rays or infrared rays, and the like may be added to the intermediate layer. A thickness of the intermediate layer 18 may be set, for example, to from 1.0 [nm] to 1.0 [mm], may be set to from 0.1 [mm] to 0.9 [mm], or may be set to from 0.2 [mm] to 0.8 [mm].

Although the glass plate structure 12 has a flat plate shape in FIG. 2, it may also have a curved shape. For example, the glass plate structure 12 may be curved so as to bulge toward a vehicle rear side when viewed from a side of the vehicle.

A light-shielding layer 13 having a predetermined width and formed by a black ceramic layer or the like is provided at an outer peripheral portion of the glass diaphragm 11, and the exciter 14 is arranged so as to overlap with the light-shielding layer 13. The exciter 14 is attached to the glass plate structure 12 via a metal or resin mount portion 16. For example, a fixing portion such as a screw or the like may be provided at one of the mount portion 16 or the exciter 14, a screw hole or the like may be provided at another of the mount portion 16 or the exciter 14, and the exciter 14 and the mount portion 16 may be mechanically fastened thereby. Although removal and replacement of the exciter 14 can be facilitated by attaching the exciter 14 to the glass plate structure 12 via the mount portion 16, the exciter 14 may also be directly (adhesively) fixed to the glass plate structure 12 without providing the mount portion 16.

Although an example in which the exciter 14 is attached to an upper end portion of the glass plate structure 12 is shown in FIG. 2, the exciter 14 may also be attached at another location. For example, the exciter 14 may be attached to a lower end portion of the glass plate structure 12. Furthermore, plural exciters 14 may also be attached to the glass plate structure 12.

The exciter 14 is connected to a power source, which is not illustrated in the drawings, and causes the glass plate structure 12 to vibrate in accordance with an input electrical signal. As an example, the exciter 14 of the present exemplary embodiment is configured as a voice coil motor including a coil portion and a magnetic circuit, one of the coil portion or the magnetic circuit is fixed to the glass plate structure 12, and the other is arranged so as to be movable relative to the glass plate structure 12. Then, due to current flowing through the coil portion, vibration is generated by interaction between the coil portion and the magnetic circuit, and the glass plate structure 12 is caused to vibrate via the mount portion 16. A vibration direction is a thickness direction of the exciter 14. It should be noted that the exciter 14 is not limited to a voice coil motor, and actuators other than a voice coil motor, such as a piezo system or the like, can be employed as long as they are actuators capable of transmitting desired vibrations to the glass plate structure 12.

A first member 18 is attached to a peripheral end portion of the glass plate structure 12 via a resin layer 20. It is sufficient for the resin layer 20 to be continuously provided over a length that is equal to or greater than half of a total length (total circumferential length) of the peripheral end portion of the glass plate structure 12. Furthermore, the length over which the resin layer 20 is continuously provided is preferably equal to or greater than 6/10, more preferably equal to or greater than 7/10, even more preferably equal to or greater than 8/10, and still more preferably equal to or greater than 9/10, of the total circumferential length of the glass plate structure 12, and it is most preferable if it is the total length (total circumferential length). The resin layer 20 of the present exemplary embodiment is provided over the entire circumference of the peripheral end portion of the glass plate structure 12. For example, even in a case in which the glass plate structure 12 is used for a window glass that is movable, such as a side glass or a roof glass, a configuration in which it comes into contact with a resin layer, such as rubber, a foam material or the like, over the entire circumference of the glass plate structure 12 when fully closed can be employed.

A Young's modulus ER of the resin layer 20 of the present exemplary embodiment, which is an adhesive layer that adheres the glass plate structure 12 and the first member 18, is preferably from 1×10⁶ [Pa] to 1×10⁸ [Pa], more preferably from 1×10⁷ [Pa] to 1×10⁸ [Pa], and still more preferably from 5×10⁷ [Pa] to 1×10⁸ [Pa].

The resin layer 20 can be configured to include at least one resin from among urethane-based, phenol-based, butyl-based, synthetic rubber-based, acryl-based, epoxy-based, silicone-based, epoxy silicone-based, and polyvinyl chloride-based resins. Furthermore, a structure may be employed in which a primer is provided in advance at the first member 18, a second member 22, and the glass plate structure 12, and, for example, as a body primer and a glass primer, a primer containing at least one component such as a polyol, a polyisocyanate, a silane coupling agent, carbon black, silica particles or the like can be used.

The first member 18 is a first frame body that surrounds the glass diaphragm 11, and as an example, the first member 18 is a back door that is made of resin. A recessed portion 18A recessed toward a vehicle front side is formed at the first member 18, and is arranged in a state in which the glass diaphragm 11 enters into the recessed portion 18A. An opening portion 18B is formed at the recessed portion 18A, and the opening portion 18B is closed off by the glass diaphragm 11.

As the first member 18, general engineering plastics, such as ABS-based, PVC-based, PC-based, PP-based, PBT-based, PA66-based, and PPS-based plastics, may be used, and fiber-reinforced plastics containing glass fibers or carbon fibers may also be used. Further, a metal reinforcement or the like that reinforces the first member 18 may be provided. The glass diaphragm module 10 may include a resin member (resin panel), which is not illustrated in the drawings, that, in the case of a resin back door using a reinforcement that reinforces the first member 18, faces the first member 18 and fixes the reinforcement so as to be interposed therebetween. Furthermore, a Young's modulus E₁ of the first member 18 is preferably from 1×10⁸ [Pa] to 1×10¹¹ [Pa], more preferably from 2×10⁸ [Pa] to 5×10¹⁰ [Pa], and still more preferably from 5×10⁸ [Pa] to 1×10¹⁰ [Pa].

Further, as shown in FIG. 1 and FIG. 2, the second member 22, which is a second frame body, is arranged at an outer side the first member 18. The second member 22 is arranged away from the glass diaphragm 11 and is connected to the first member 18. In FIG. 2, a lower end portion of the first member 18 is superposed with a surface at a vehicle rear side of the second member 22. Furthermore, sides at both left and right end portions of the first member 18 are similarly superposed with the second member 22 (refer to FIG. 1).

As shown in FIG. 2, an upper end portion of the first member 18 is connected to the second member 22 via a connection portion 24. The connection portion 24 includes a fixing member that mechanically fixes the first member 18 and the second member 22, and, for example, a hinge that couples the first member 18 to the second member 22 so as to be capable of swinging can be used as the connection portion 24.

Further, the first member 18 and the second member 22 may be adhered with an adhesive, and a fastening member, such as a bolt or the like, and the adhesive may be used in combination.

The second member 22 is configured to contain a metal, and may be an outer plate of the vehicle that is made of metal, or the like. In a case in which the first member 18 is configured as a back door that is made of resin, the second member 22 may be an outer plate of the vehicle that supports the back door. As the metal configuring the second member 22, aluminum, iron, stainless steel, or the like can be used.

A Young's modulus E₂ of the second member 22 is preferably from 1×10¹⁰ [Pa] to 1×10¹² [Pa], more preferably from 2×10¹⁰ [Pa] to 5×10¹¹ [Pa], and still more preferably from 5×10¹⁰ [Pa] to 1×10¹¹ [Pa].

In this regard, in a case in which the Young's modulus of the first member 18 is defined as E₁ and the Young's modulus of the second member 22 is defined as E₂, a ratio of the Young's modulus E₁ and the Young's modulus E₂ is designed so as to satisfy E₂/E₁≥10. Due to using the first member 18 and the second member 22, which satisfy this relational expression, vibration of the glass plate structure 12 that is generated due to vibration of the exciter 14 can be attenuated by the first member 18, and propagation of the vibration to the second member 22 can be suppressed. It should be noted that the ratio of the Young's modulus E₁ and the Young's modulus E₂ preferably satisfies E₂/E₁≥20, more preferably satisfies E₂/E₁≥30, and still more preferably satisfies E₂/E₁≥50.

In particular, in the glass diaphragm module 10, which satisfies the above-described ratio (E₂/E₁), in a case in which the glass diaphragm 11 is used for a window glass for a vehicle, it is possible to effectively suppress propagation of the vibration of the exciter 14 to an entirety of outer plates of the vehicle. Further, even in a case in which a highly-rigid adhesive having a Young's modulus ER of 1×10⁷ [Pa] or more is used as the resin layer 20 for (adhesively) fixing the glass plate structure 12 and the first member 18, since vibration can be attenuated by the first member 18, propagation of vibration can be suppressed, and generation of noise, which is a component that is different from sound that is generated by causing the glass plate structure 12 to vibrate, can be suppressed, while firmly fixing the glass plate structure 12 to the first member 18.

Furthermore, in a case in which the first member 18 is configured as a back door that is made of resin, weight can be reduced as compared to a back door that is made of metal, and fuel efficiency of the vehicle can be improved.

### Second Exemplary Embodiment

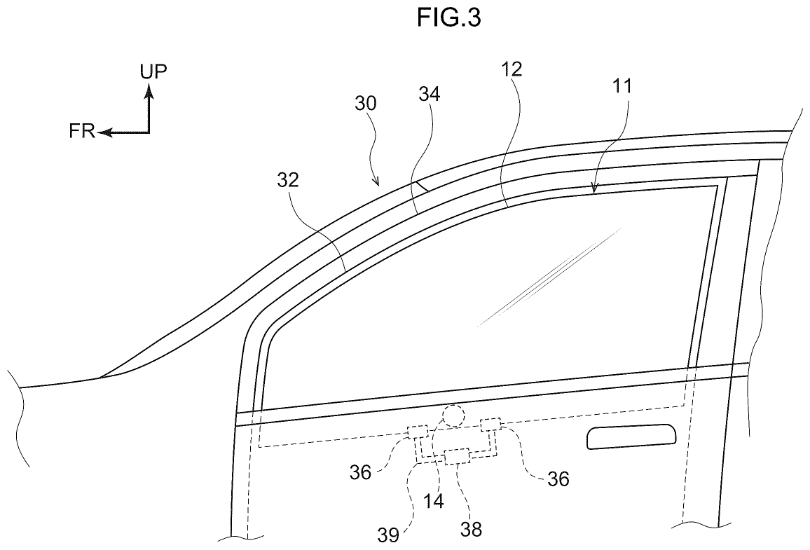

A glass diaphragm module 30 according to a second exemplary embodiment will be explained with reference to FIG. 3. It should be noted that, in the second exemplary embodiment, configurations that are the same as those in the first exemplary embodiment are denoted by the same reference numerals, and explanation thereof will be appropriately omitted.

FIG. 3 is a schematic view of the glass diaphragm module 30 according to the second exemplary embodiment as viewed from a side of a vehicle. As illustrated in FIG. 3, the glass diaphragm module 30 of the present exemplary embodiment includes the glass diaphragm 11, and the glass diaphragm 11 includes the glass plate structure 12 and the exciter 14.

FIG. 3 is an example in which the glass plate structure 12 is used for a side glass that is arranged at a side portion of the vehicle so as to be capable of sliding. The glass plate structure 12 has the same structure as that of the first exemplary embodiment, and is formed in a shape of a side glass.

The exciter 14 is attached to a lower end portion of the glass plate structure 12. The exciter 14 is positioned at an inner side of a door panel even in a fully closed state in which the glass plate structure 12 is positioned at an uppermost side, and therefore, is not visible to an occupant. It should be noted that, when a slidable side glass is fully closed in a vehicle, a side that corresponds to a portion that overlaps with a lower side of an opening portion is referred to as a belt line, and the exciter 14 can be arranged in an arbitrary region as long as it is in a region that is below the belt line.

In FIG. 3, a pair of holders 36 are attached to a lower end portion of the glass plate structure 12 in a front-rear direction. The holders 36 are formed in substantially a U-shape as viewed from the vehicle front-rear direction (an end surface direction of the glass plate structure 12), clamp the lower end portion of the glass plate structure 12, and support the glass plate structure 12 from below. The pair of holders 36 are coupled to a slider 38, and the slider 38 is configured so as to be movable up and down along a guide rail, which is not illustrated in the drawings. As a result, the glass plate structure 12 slides up and down due to the slider 38 moving up and down. It should be noted that, although an example in which two holders 36 are provided is illustrated in FIG. 3, one holder or three or more holders may be provided.

A first member 32 that is made of resin is attached to a peripheral end portion of the glass diaphragm 11 via a resin layer, which is not illustrated in the drawings. The first member 32 is continuously provided in a region that is equal to or greater than half of the peripheral end portion of the glass diaphragm 11, and in FIG. 3, the first member 32 is arranged in a region excluding a lower edge of the glass diaphragm 11. It should be noted that a weather strip that seals between the side glass and a vehicle body may be used as the first member 32.

A second member 34 that is made of metal is arranged away from the glass diaphragm 11. The second member 34 is connected to the first member, and in FIG. 3, a door frame is used as the second member 34. In this regard, in a fully closed state of the glass diaphragm 11, the first member 32 is brought into close contact with the second member 34.

It is sufficient if a Young's modulus E₁ of the first member 32 and a Young's modulus E₁ of the second member 34 satisfy E₂/E₁≥10, and the ranges explained in the first exemplary embodiment can be applied as preferred ranges.

### Third Exemplary Embodiment

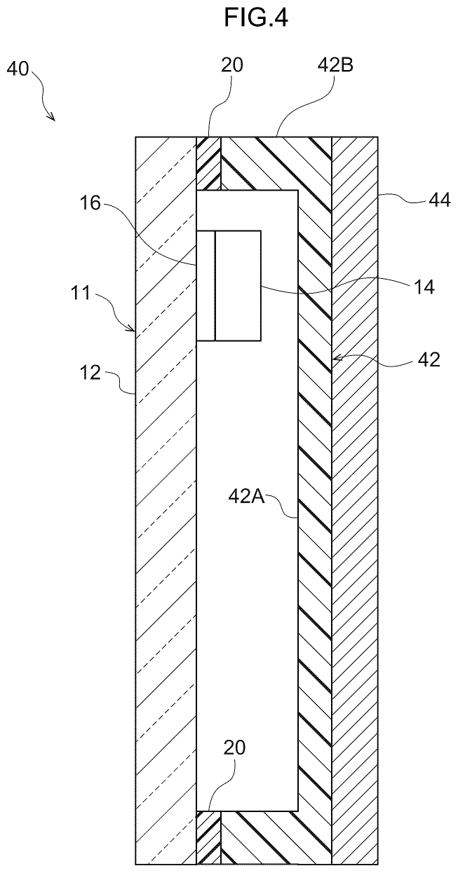

A glass diaphragm module 40 according to a third exemplary embodiment will be explained with reference to FIG. 4. It should be noted that configurations that are the same as those in the first exemplary embodiment are denoted by the same reference numerals, and explanation thereof will be appropriately omitted.

FIG. 4 is a cross-sectional view of the glass diaphragm module 40 according to the third exemplary embodiment as viewed from the side. As shown in FIG. 4, the glass diaphragm module 40 of the present exemplary embodiment includes the glass diaphragm 11, and the glass diaphragm 11 includes the glass plate structure 12 and the exciter 14.

Although the glass plate structure 12 illustrated in FIG. 4 has the same structure as that of the first exemplary embodiment, and is formed as a single-plate glass in a substantially rectangular plate shape, it may also be a laminated glass. Further, the exciter 14 is attached to a main surface at one side of the glass plate structure 12 via the mount portion 16.

A first member 42 is attached to the main surface at the one side of the glass plate structure 12 via the resin layer 20. The resin layer 20 has the same configuration as that of the first exemplary embodiment, and is provided over the entire circumference of the peripheral end portion of the glass plate structure 12.

The first member 42 includes a bottom portion 42A that faces the main surface of the glass plate structure 12, and a peripheral wall portion 42B that protrudes from a peripheral end portion of the bottom portion 42A toward a glass plate structure 12 side, and the peripheral wall portion 42B is adhered to the glass diaphragm 11 via the resin layer 20. As the first member 42, the same material as that in the first exemplary embodiment can be used.

Then, a second member 44 is arranged away from the glass diaphragm 11, and the second member 44 is connected to the first member 42. The second member 44 is a substantially rectangular plate-shaped member that is fixed to the bottom portion 42A of the first member 42, and the same material as that in the first exemplary embodiment can be used.

It is sufficient if a Young's modulus E₁ of the first member 42 and a Young's modulus E₂ of the second member 44 satisfy E₂/E₁≥10, and the ranges explained in the first exemplary embodiment can be applied as preferred ranges.

Even in a structure in which the second member 44 is not a frame body as in the present exemplary embodiment, it is possible to effectively suppress propagation of sound that is generated due to the glass plate structure 12 being caused to vibrate due to vibration of the exciter 14, to the exterior (via a frame body). It should be noted that the glass diaphragm module 40 of the present exemplary embodiment can be used for an electronic device or the like.

### Fourth Exemplary Embodiment

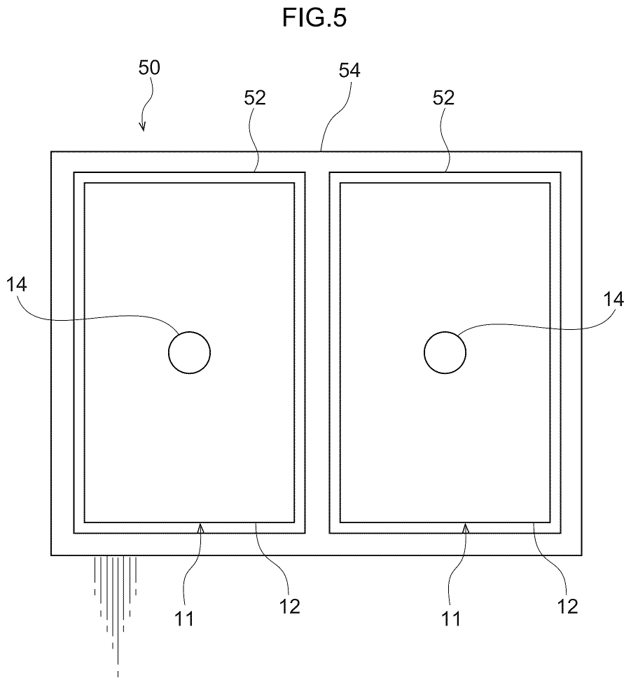

A glass diaphragm module 50 according to a fourth exemplary embodiment will be explained with reference to FIG. 5. It should be noted that configurations that are the same as those in the first exemplary embodiment are denoted by the same reference numerals, and explanation thereof will be appropriately omitted.

FIG. 5 is a schematic view of an example in which the glass diaphragm module 50 according to the fourth exemplary embodiment is applied to an architectural window glass for a building, as viewed from an indoor side. As shown in FIG. 5, the glass diaphragm module 50 of the present exemplary embodiment includes a pair of left and right glass diaphragms 11, and each glass diaphragm 11 includes a glass plate structure 12 and an exciter 14.

Although each glass plate structure 12 illustrated in FIG. 5 has the same structure as that of the first exemplary embodiment, and is formed as a single-plate glass in a substantially rectangular plate shape, they may also be a laminated glass. Further, FIG. 5 illustrates a structure in which the glass plate structure 12 partitions an interior and an exterior of the building, and the exterior is visible from the interior of the building through the glass plate structure 12. Furthermore, although the glass plate structure 12 is used for a (fixed) window glass that cannot be opened and closed, it may also be used for a window glass that can be opened and closed.

The exciter 14 is attached to the glass plate structure 12. Although the exciter 14 is attached to a central portion of the glass plate structure 12, it may also be attached to a peripheral end portion of the glass plate structure 12. Furthermore, the portion to which the exciter 14 is attached may be covered with an interior finishing material or the like.

A first member 52 is attached to a peripheral end portion of each glass diaphragm 11 via a resin layer, which is not illustrated in the drawings. The first member 52 is a first frame body that surrounds the glass diaphragm 11, and the same resin as that in the first exemplary embodiment can be used.

A second member 54, which is a second frame body, is arranged at an outer side of the first members 52. The second member 54 is arranged away from the glass diaphragms 11 and is connected to the first members 52. In FIG. 5, the second member 54 is formed in a shape that surrounds a periphery of the two first members 52, and is formed of a metal that supports the glass diaphragms 11. It should be noted that the same metal as that in the first exemplary embodiment can be used for the second member 54. In this regard, it is sufficient if a Young's modulus E₁ of the first members 52 and a Young's modulus E₂ of the second member 54 satisfies E₂/E₁≥10, and the ranges explained in the first exemplary embodiment can be applied as preferred ranges.

By applying the glass diaphragm 11 to an architectural window glass as in the present exemplary embodiment, it is possible to suppress propagation of sound that is generated due to the glass plate structure 12 being caused to vibrate due to vibration of the exciter 14, to a wall of a building (via a frame body).

### Example

The exemplary embodiments of the present disclosure will be explained more concretely below with reference to an Example. Materials, dimensions, shapes, and evaluation procedures indicated in the following Example can be appropriately modified without departing from the spirit of the exemplary embodiments of the present disclosure. Accordingly, the scope of the exemplary embodiments of the present disclosure is not limited to the specific examples indicated below.

### (Glass Plate Structure)

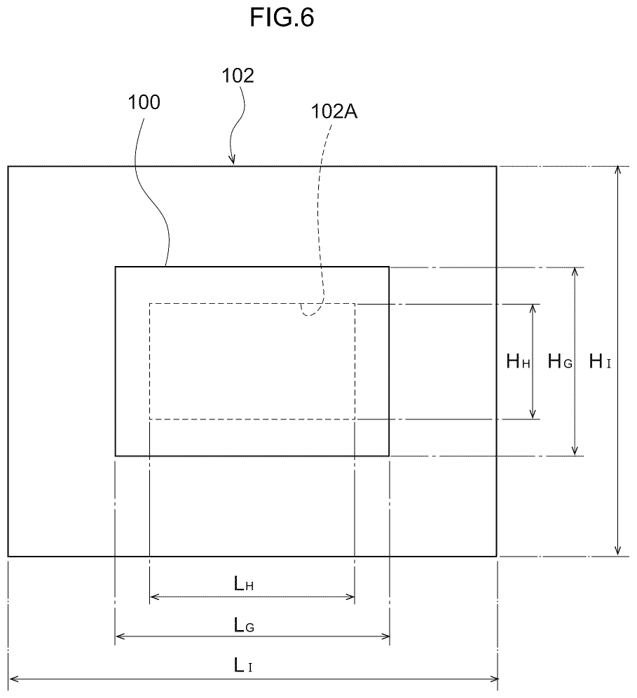

FIG. 6 is a front view illustrating a state in which a glass diaphragm module 110 of the Example is in the process of being assembled. As illustrated in FIG. 6, a glass plate structure 100 is a single-plate glass, and is formed in a substantially rectangular plate shape. A length LG of the glass plate structure 100 in a longitudinal direction thereof is 300 [mm], and a length HG of the glass plate structure 100 in a short-side direction thereof is 200 [mm]. Furthermore, a thickness of the glass plate structure 100 is 3.2 [mm].

### (First Member)

A first member 102 is a first frame body that is formed of a PVC-based resin, and has an opening portion 102A formed at a central portion thereof. A length L₁ of the first member 102 in a longitudinal direction thereof is 520 [mm], and a length H₁ of the first member 102 in a short-side direction thereof is 420 [mm]. Furthermore, a thickness of the first member 102 is 3.0 [mm]. A length L_{H} of the opening portion 102A in a longitudinal direction thereof is 220 [mm], and a length H_{H} of the opening portion 102A in a short-side direction thereof is 120 [mm].

### (Resin Layer)

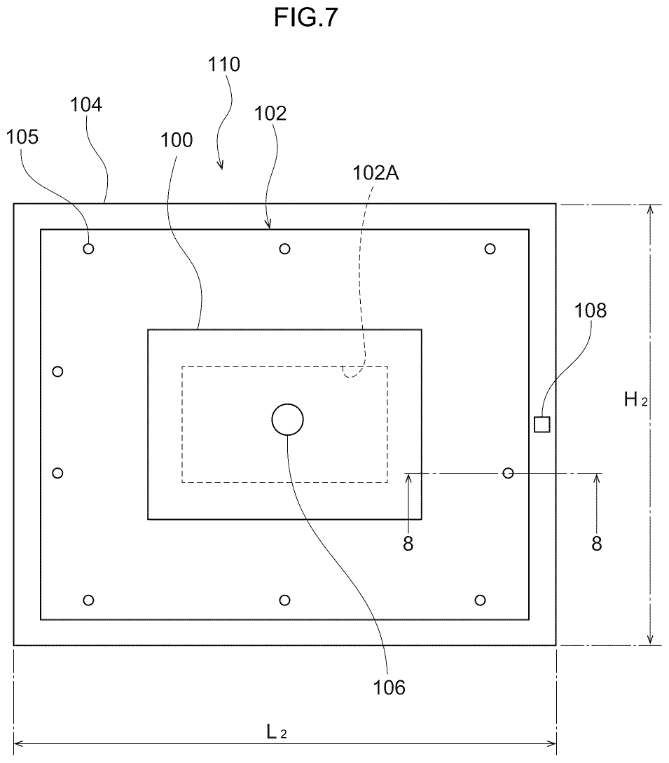

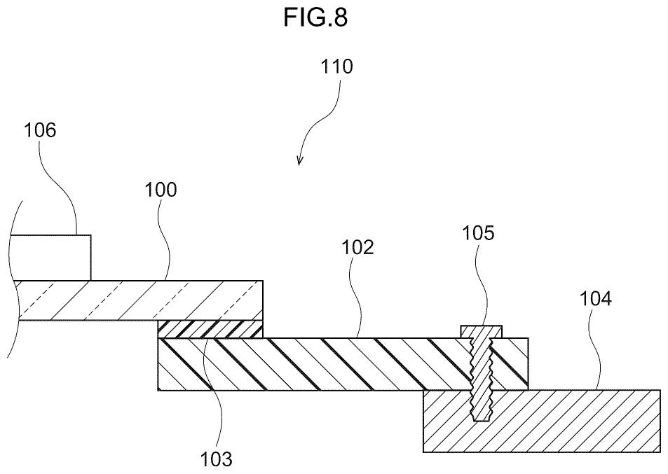

FIG. 7 is a front view illustrating the glass diaphragm module 110 of the Example, and FIG. 8 is a cross-sectional view taken along line 8-8 in FIG. 7, with a portion cut away. As illustrated in FIG. 8, the first member 102 is attached to a peripheral end portion of the glass plate structure 100 via a resin layer 103. As the resin layer 103, an adhesive (Sika Tack® GO!, manufactured by Sika Japan, Ltd.) that adheres the glass plate structure 100 and the first member 102 is used. A width of the resin layer 103 is 2.4 [mm], and a thickness thereof is 6.4 [mm].

### (Second Member)

As illustrated in FIG. 7 and FIG. 8, the second member 104 is a second frame body that is formed from aluminum, a length L₂ of the second member 104 in a longitudinal direction thereof is 550 [mm], and a length H₂ of the second member 104 in a short-side direction thereof is 450 [mm]. Furthermore, a thickness of the second member 104 is 3.0 [mm].

### (Connection Portion)

The first member 102 and the second member 104 were mechanically fastened by plural screws 105, serving as a connection portion. The screws 105 were arranged at 10 locations spaced apart from each other at a periphery of the first member 102.

### (Exciter)

As illustrated in FIG. 7, an exciter 106 was attached to a center of the glass plate structure 100 with an adhesive tape (9473PC, manufactured by 3M). A vibration direction of the exciter 106 is a thickness direction of the glass plate structure 100, and the exciter 106 was configured to be capable of vibrating at a period corresponding to an input signal.

An acceleration sensor 108 (NP-3200, manufactured by Ono Sokki Co., Ltd.) was attached to a peripheral end portion of the second member 104. Analysis processing of measurement data that was measured by the acceleration sensor 108 was performed by a real-time acoustic vibration analysis system (DS-3200, manufactured by Ono Sokki Co., Ltd.).

### (Measurement Method)

Sine waves of 40 [Hz], 60 [Hz], 80 [Hz], and 100 [Hz] were applied to the exciter 106 at 1 [V], and a magnitude of acceleration at each frequency was measured by the acceleration sensor 108. Furthermore, the same measurement was performed with the material of the first member 102 replaced with aluminum. It should be noted that, in a case in which the first member 102 is PVC, E₂/E₁=20, and the Young's modulus E₁ of the first member 102 and the Young's modulus E₂ of the second member 104 satisfy E₂/E₁≥10, but that, in a case in which the first member 102 is aluminum, E₂/E₁=1, and the above condition is not satisfied.

### (Measurement Results)

The measurement results are as shown in Table 1 below.

TABLE 1

| Material of first member | 40 Hz | 60 Hz | 80 Hz | 100 Hz |
|---|---|---|---|---|
| PVC | 0.47 | 0.48 | 0.29 | 0.12 |
| Aluminum | 1.82 | 1.57 | 0.99 | 0.48 |

From the results shown in Table 1, due to using PVC as the first member 102, a value measured by the acceleration sensor was reduced. In other words, vibration of the exciter 106 was greatly attenuated by the first member 102. In particular, in a low frequency region in which an amplitude value is large, an effect of attenuating vibration to the second member became remarkable, and it was possible to greatly suppress an amount of noise generated.

From the above results, for example, in a glass diaphragm that is fixed to an automotive door formed from a resin material, vibration is less likely to be propagated to a metal frame serving as a housing, which is extremely effective in applications in which a glass is vibrated. Similarly, this is widely applicable to products in which a glass is caused to vibrate, in an architectural window glass, an electronic device, or the like. It should be noted that, as long as the Young's modulus E₁ of the first member and the Young's modulus E₂ of the second member satisfy E₂/E₁≥10, the first member may be formed from a material other than a resin, and the second member may be formed from a material other than a metal.

Although the glass diaphragm modules 10, 30, 40, and 50 according to the exemplary embodiments have been explained above, it is needless to say that the present disclosure can be implemented in various forms in a range that does not depart from the gist of the present disclosure.

All documents, patent applications, and technical standards that are mentioned herein are incorporated herein by reference to the same extent as if each individual document, patent application, and technical standard was specifically and individually indicated to be incorporated by reference.

1. A glass diaphragm module comprising:
a glass diaphragm including a glass plate structure and an exciter that is attached to the glass plate structure;
a first member that is attached to a peripheral end portion of the glass diaphragm via a resin layer; and
a second member that is arranged away from the glass diaphragm and that is connected to the first member,
wherein a Young's modulus E₁ of the first member and a Young's modulus E₂ of the second member satisfy E₂/E₁≥10.

2. The glass diaphragm module according to claim 1, wherein the resin layer is continuously provided in a region that is equal to or greater than half of the peripheral end portion of the glass diaphragm.

3. The glass diaphragm module according to claim 1, wherein the resin layer is provided over an entire circumference of the peripheral end portion of the glass diaphragm.

4. The glass diaphragm module according to claim 1, wherein the resin layer is an adhesive layer that adheres the glass diaphragm and the first member.

5. The glass diaphragm module according to claim 1, wherein a Young's modulus ER of the resin layer is from 1×10⁶ [Pa] to 1×10⁸ [Pa].

6. The glass diaphragm module according to claim 1, wherein the Young's modulus E₁ of the first member is from 1×10⁸ [Pa] to 1×10¹¹ [Pa].

7. The glass diaphragm module according to claim 1, wherein the first member contains a resin.

8. The glass diaphragm module according to claim 1, wherein:
the second member is connected to the first member via a connection portion, and
the connection portion includes a fixing member that mechanically fixes the first member and the second member.

9. The glass diaphragm module according to claim 8, wherein the connection portion includes an adhesive that adheres the first member and the second member.

10. The glass diaphragm module according to claim 1, wherein the Young's modulus E₂ of the second member is from 1×10¹⁰ [Pa] to 1×10¹² [Pa].

11. The glass diaphragm module according to claim 1, wherein the second member contains a metal.

12. The glass diaphragm module according to claim 1, wherein:
the first member is a first frame body,
the second member is a second frame body, and
the second frame body is arranged at an outer side of the first frame body.

13. The glass diaphragm module according to claim 1, wherein the glass plate structure is a single-plate glass.

14. The glass diaphragm module according to claim 1, wherein the glass plate structure is a laminated glass in which an intermediate layer is interposed between a pair of glass plates.

15. The glass diaphragm module according to claim 1, wherein the glass plate structure is a window glass for a vehicle.

16. The glass diaphragm module according to claim 15, wherein the glass plate structure is a rear glass that is arranged at a rear portion of the vehicle.

17. The glass diaphragm module according to claim 16, wherein the first member is a back door that is made of resin.

18. The glass diaphragm module according to claim 1, wherein the glass plate structure is a side glass that is arranged at a side portion of a vehicle so as to be capable of sliding.

19. The glass diaphragm module according to claim 15, wherein the second member is an outer plate of a vehicle that is made of a metal.

20. The glass diaphragm module according to claim 1, wherein the glass plate structure is a window glass for a railway, an aircraft, or architecture.
